(19) United States
(12) Patent Application Publication
(10) Pub. No.: US 2020/0173487 A1
(43) Pub. Date: Jun. 4, 2020

(54) SCREW SECURING DEVICE AND METHOD FOR SECURING THE SCREW

(71) Applicant: ZF Friedrichshafen AG, Friedrichshafen (DE)

(72) Inventors: Michael PANTKE, Friedrichshafen (DE); Gabriel WAGNER, Attenweiler (DE); Florian WEINL, Bodolz (DE); Bernhard WALTER, Friedrichshafen (DE); Alexander BLASER, Friedrichshafen (DE); Michael LINDER, Kressbronn am Bodensee (DE)

(21) Appl. No.: 16/701,239

(22) Filed: Dec. 3, 2019

(30) Foreign Application Priority Data
Dec. 4, 2018 (DE) 10 2018 220 878.6

(51) Int. Cl. F16B 41/00

(52) U.S. Cl. CPC F16B 41/002

(57) ABSTRACT

A securing device (1) for a screw (2), including a component (3) having at least one screw opening (4). The screw opening (4) has a first bore (5) and a second bore (6) in which the first bore (5) has a smaller bore diameter and a larger bore depth than the second bore (6). The securing device (1) also has an annular expansion element (7) that can be fitted into the second bore (6) and is designed to expand radially and to press its outer circumference (7″) against an inner circumference of the second bore (6) when the screw (2) is introduced into an annular opening (7′) of the expansion element (7). Also described is a method for securing a screw (2) in a screw opening (4) utilizing the securing device (1).

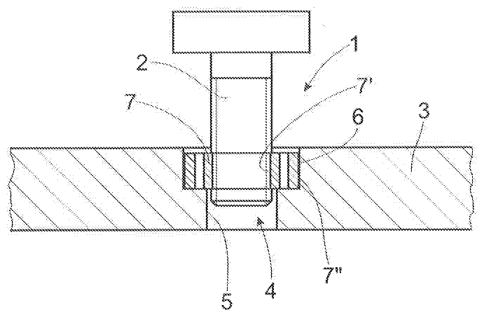

This application claims priority from German patent application serial no. 10 2018 220 878.6 filed Dec. 4, 2018.

### FIELD OF THE INVENTION

The present invention relates to a securing device for a screw and to a method for securing a screw in a screw opening.

### BACKGROUND OF THE INVENTION

From the prior art, loss-prevention devices for screws are known and which are designed to prevent a screw from falling out of the screw opening, after an intentional or even unintentional loosening of the screw. For example it is known to arrange a thin plastic platelet in a screw opening by caulking. Then, when the screw is loosened, it sticks to the plastic platelet and cannot fall out of the screw opening and get lost. Furthermore the use of self-tapping screws is also known, which are self-retaining in the screw opening.

In this connection FR 2 765 293 discloses a cap-shaped loss-prevention device which, after a screw is inserted, is positioned onto the screw and is attached by a clip to a component in which the screw opening is formed.

From DE 10 2012 219 065 A1 a loss-prevention device for a screw is known. The loss-prevention device has a circumferential section with a recess, such that the circumferential section is designed to be arranged on or in an assembly opening in such manner that the recess is over the assembly opening. The circumferential section has at least one tongue which extends radially inward from the outer circumferential section into the disk-shaped recess. In this case at least the tongue consists of an elastic material.

DE 20 2008 016 163 U1 discloses a device for securing a pre-fitted screw in a component, which has a through-going bore. The device is in the form of a holding bracket which surrounds the component in a form-enclosing manner and has bracket bore aligned with the through-bore, which has a smaller diameter than the holding bore.

However, the known loss-prevention devices all have the disadvantage that they are comparatively expensive. When self-tapping screws are used, stresses are also produced in the bore which can extend into the component having the screw opening and can damage the component.

### SUMMARY OF THE INVENTION

The object of the present invention is to propose an improved securing device for a screw.

According to the invention, this objective is achieved by a securing device for a screw according to the independent claim(s). Advantageous design features and further developments of the invention emerge from the dependent claims.

The invention relates to a securing device for a screw, which comprises a component with at least one screw opening, wherein the screw opening has a first bore and a second bore such that the first bore has a smaller bore diameter and a larger bore depth than the second bore. The securing device according to the invention for a screw is characterized in that the securing device also has an annular expansion element which can be fitted inside the second bore and is designed to expand radially, when a screw is introduced into an annular opening of the expansion element, and to press with its outer circumference against an inner circumference of the second bore.

Thus, in its function the expansion element corresponds in principle to a so-termed screw-plug, in which the introduction of a screw into it results in a radial expansion of its outer circumference. Accordingly the outer circumference of the expansion element presses against an inner circumference of the second bore, resulting in static friction that holds the expansion element in the second bore. At the same time the screw presses the annular opening radially outward, which also results in static friction, in this case between the screw and the expansion element. In contrast to an ordinary screw-plug, however, the expansion element of a securing device according to the invention is not tubular with a closed axial end, but annular with two open axial ends.

The first bore is preferably provided for receiving the screw, in particular so that the screw can be screwed into it, and the second bore is preferably provided for receiving the expansion element. Particularly preferably, the expansion element can be inserted into the second opening first with no further fixing steps, for example simply fitted into it.

This has the advantage that the screw itself, even if the screw joint is completely undone, cannot fall out of the screw opening and get lost, so long as the force acting on it is not greater than the static friction force holding the expansion element in the second bore and not greater than the static friction force holding the screw in the expansion element.

An advantage of the securing device according to the invention compared with the known securing devices is also that the securing device not only secures the screw against falling out of the screw opening, but also due to the static friction between the screw and the expansion element and the static friction between the expansion element and the internal circumference of the second bore, it can hold the screw in the screw opening in a defined position, for example perpendicularly. The securing device according to the invention for a screw is therefore advantageously suitable for pre-fitting, i.e. for the preparatory arrangement of the screw in the screw opening prior to a later assembly step in which the screw is finally screwed into the screw opening. For this, in a first assembly step for example at a first assembly location the screw and the expansion element together can be positioned in the screw opening, and then, in a further assembly step for example after the component with the securing device in place has been transported to a further assembly location, the screw can be screwed into the screw opening.

According to a preferred embodiment of the invention it is provided that the expansion element consists of a plastic. Plastic can, on the one hand, be robust but, on the other hand, be elastic enough to hold the screw in the screw opening even if the screw has been loosened. Furthermore, plastic is inexpensive, simple to produce and easy to process.

According to another preferred embodiment of the invention, it is provided that the first bore has an internal thread that matches the screw thread. This has the advantage that the screw can be screwed into the first bore and can there fulfill a holding function for one or more connected components. If the screw is unintentionally loosened from the internal thread of the first bore, the screw is held by the securing device according to the invention.

In a further preferred embodiment of the invention, it is provided that an internal diameter of the annular opening is smaller than a diameter of the screw. This has the advantage that the insertion of the screw results in a radial expansion of the expansion element, so that on the one hand the expansion element presses with its outer circumference against the inner circumference of the second bore, such that the expansion element cannot fall out of the second bore. On the other hand a force is also exerted by the expansion element on the screw due to the expansion and the elasticity of the expansion element, so that the screw cannot fall out of the expansion element. Thus, the screw is held in the expansion element and the expansion element is held in the second bore.

According to a further preferred embodiment of the invention, it is provided that the first bore is a through-going bore. This makes it advantageously possible to screw the screw thread of the screw right through the component provided with the securing device and then screw it into another component that has a correspondingly formed internal thread, in order to join the component having the securing device to the other component.

The invention also relates to a method for securing a screw in a screw opening, wherein the screw opening has a first bore and a second bore, the first bore having a smaller bore diameter and a larger bore depth than the second bore. The method according to the invention is characterized in that an annular expansion element is inserted into the second bore and the screw is introduced into an annular opening of the expansion element so that the expansion element expands radially, thereby pressing with its outer circumference against the inner circumference of the second bore.

The method according to the invention thus describes the use of the securing device according to the invention. This results in the advantages already mentioned.

The method according to the invention is suitable not only for preventing the loss of the screw, but also for the preparatory positioning of the screw in the screw opening for a subsequent assembly step.

### BRIEF DESCRIPTION OF THE DRAWINGS

Below, the invention is explained with reference to an example embodiment illustrated in the sole FIGURE, which shows a schematic illustration of an example of a possible embodiment of the securing device according to the invention for a screw.

### DETAILED DESCRIPTION OF THE PREFERRED EMBODIMENTS

The FIGURE is a schematic illustration of an example of a possible embodiment of the securing device 1 according to the invention for a screw 2. For example, a component 3 with a screw opening 4 accommodates the securing device, wherein the screw opening 4 has a first bore 5 and a second bore 6. The first bore 5 has an internal thread that matches a thread on the screw 2, so that the screw 2 can be screwed into the first bore 5. Furthermore, the first bore 5 is formed as a through-going bore. This makes it possible for the screw 2 to be screwed right through the component 3 and screwed into a further component (not shown in the FIGURE) also having an internal thread, in order to connect the component 3 to the further component. As can also be seen in the FIGURE, the first bore 5 has a smaller bore diameter and a larger bore depth than the second bore 6. The securing device 1 also comprises an annular expansion element 7 made of plastic, which is fitted inside the second bore 6. An inside diameter of an annular opening 7′ of the expansion element 7 is smaller than a diameter of the screw 2, so that when the screw 2 has been introduced into the annular opening 7′ of the expansion element 7 the expansion element expands radially in such manner that the expansion element 7 presses with its outer circumference 7″ against an inner circumference of the second bore 6. Thus, static friction is produced between the outer circumference 7″ of the expansion element 7 and the inner circumference of the second bore 6, this friction holding the expansion element 7 in the second bore 6 and preventing it from falling out. Likewise, static friction is produced between the inner circumference 7′ of the expansion element 7 and the screw 2, which holds the screw 2 in the expansion element 7 and prevents the screw 2 from falling out of the screw opening 4 and getting lost.

### INDEXES

1 Securing device
2 Screw
3 Component
4 Screw opening
First bore
6 Second bore
7 Expansion element
7′ Annular opening of the expansion element
7″ Outer circumference of the expansion element

1-6. (canceled)

7. A securing device (1) for a screw (2), the securing device (1) comprising:
a component (3) having at least one screw opening (4),
the screw opening (4) having a first bore (5) and a second bore (6),
the first bore (5) having a smaller bore diameter and a larger bore depth than the second bore (6),
the securing device (1) further comprising an annular expansion element (7) that can be fitted inside the second bore (6) and being designed, when the screw (2) is introduced into an annular opening (7′) of the expansion element (7), to expand radially and press an outer circumference of the expansion element (7) against an inner circumference of the second bore (6).

8. The securing device (1) according to claim 7, wherein the expansion element (7) is made of plastic.

9. The securing device (1) according to claim 7, wherein the first bore (5) has an internal thread which matches an external thread of the screw (2).

10. The securing device (1) according to claim 7, wherein an inside diameter of the annular opening is smaller than a diameter of the screw.

11. The securing device (1) according to claim 10, wherein the first bore (5) is a through-going bore.

12. A method for securing a screw (2) in a screw opening (4), the screw opening (4) has a first bore (5) and a second bore (6), the first bore (5) has a smaller bore diameter and a larger bore depth that the second bore (6), the method comprising:
fitting an annular expansion element (7) into the second bore (6); and
introducing the screw (2) into an annular opening (7′) of the expansion element (7) so that the expansion element (7) expands radially and presses its outer circumference (7″) of the expansion element (7) against an inner circumference of the second bore (6).

13. A securing device for a screw, the securing device comprising:
a component having a screw opening;
the screw opening having a first bore and a second bore;
the first and the second bores being axially aligned with one another;
the first bore extending axially completely through the component from a first side of the component to a second side of the component;
the second bore extending axially partially through the component from the first side of the component;
a diameter of the first bore being smaller than a diameter of the second bore;
an annular expansion element being received within the second bore,
the expansion element having an annular inner opening and outer circumference; and
the inner opening of the expansion element receiving the screw therein which radially expands the expansion element such that the outer circumference of the expansion element radially presses against an inner circumference of the second bore for preventing the screw from falling out of the screw opening.
